(19) United States
(12) Patent Application Publication
(10) Pub. No.: US 2024/0351227 A1
(43) Pub. Date: Oct. 24, 2024

(54) NOSE HAIR TRIMMER HAVING ANTIBACTERIAL FUNCTION

(71) Applicant: TAERIM BIOTECH CO., LTD., Seoul (KR)

(72) Inventors: Jae-Hyeok MOON, Seoul (KR); Jae-Hoon MOON, Seoul (KR)

(73) Assignee: TAERIM BIOTECH CO., LTD., Seoul (KR)

(21) Appl. No.: 18/684,696

(22) PCT Filed: Aug. 20, 2021
(86) PCT No.: PCT/KR2021/011100

§ 371 Date: Feb. 19, 2024

(51) Int. Cl. B26B 19/14; A01N 25/34; A01N 59/20; A01P 1/00; B26B 19/38

(52) U.S. Cl. CPC B26B 19/148; A01N 25/34; A01N 59/20; A01P 1/00; B26B 19/3833; B26B 19/3873

(57) ABSTRACT

The present invention relates to a nose hair trimmer having an antibacterial function, more specifically to a nose hair trimmer having an antibacterial function that is capable of preventing the inside and outside of a body thereof from being contaminated with all types of bacteria in such a way as to allow a portion coming into contact with the inside of the nose to be kept at a clean state while nose hairs are being trimmed, thereby building and keeping more sanitary nose hair trimming environments.

### TECHNICAL FIELD

The present invention relates to a nose hair trimmer having an antibacterial function, more specifically to a nose hair trimmer having an antibacterial function that is capable of preventing the inside and outside thereof from being contaminated with all types of bacteria in such a way as to allow a portion coming into contact with the inside of the nose to be kept at a clean state while nose hairs are being trimmed, thereby building and keeping more sanitary nose hair trimming environments.

### BACKGROUND ART

Nose hairs grow long as time passes, and unless they are managed in a beauty salon, generally, people directly trim their nose hairs. Most of them trim the nose hairs by means of small scissors, but in this case, they may feel nervous. Further, their nostrils may hurt so that they may be infected with germs. Therefore, the nose hairs have to be very carefully trimmed.

A nose hair trimmer is configured to rotate a rotating blade through a motor operating with a battery and trim nose hairs by means of the rotation of the rotating blade. In this case, if a front part of the nose hair trimmer is excessively pushedly inserted into the inside of the nose to trim the nose hairs, the front part may be somewhat distorted due to a user's pressurizing force, so that the rotating blade may cause the inner skin of the nose to hurt. Further, the nose hairs are generally thin, long, and a little entangled, unlike relatively strong beard or sideburns, and to allow such nose hairs to be trimmed closely, therefore, it is desirable that the nose hair trimmer be configured differently from a general beard trimmer.

In the case of a device where a cutting blade rotates with the operation of a motor to trim nose hairs, it is very inconvenient in the use of the nose hair trimming device because of frequent failures and battery exchange problems, and since the nose hairs grow in irregular directions, further, it is hard to trim them efficiently.

Besides, a user have a cough or a runny nose due to the inherent vibrations generated from the motor operating for the rotation of the cutting blade, thereby making him or her feel unpleasant, and in such a trimming process, further, his or her nasal discharge may be introduced into the nose hair trimming device.

As a result, the nose hairs are not trimmed properly, and if the nose hair trimming device is not frequently cleaned, it may smell and cause bacteria to live therein, thereby making it unsanitary.

A manual rotation type nose hair trimmer as one of conventional nose hair trimmers is disclosed in Korean Patent Application Laid-open No. 2004-13331, wherein the nose hair trimmer is configured to trim nose hairs located at the deep position of the inside of the nose with only a single operation by using horizontal and vertical blades, without using any motor and battery. However, in this case, the conventional nose hair trimmer does not have any gap in which the rotating blade is movable in up, down, left and right directions, and therefore, it is difficult that the nose hair trimmer trims thin, long, and a little entangled nose hairs, unlike beard or sideburns, by appropriate lengths, while preventing the inner skin of the nose from getting hurt.

If the nose hairs are trimmed too short, they do not perform their functions, inherent and therefore, it is undesirable to trim the nose hairs too short. However, if the nose hairs are not trimmed at all, the nose hair trimmer loses its function. Accordingly, a nose hair trimmer, which is newly configured to trim nose hairs properly when the nose hairs grow long, is needed.

Another conventional nose hair trimmer is disclosed in Korean Patent No. 10-1263248, which is improved in an installation structure of a rotating blade to allow thin, long, and a little entangled nose hairs to be trimmed well to proper lengths, without causing the inner skin of the nose to hurt. The conventional nose hair trimmer is issued to the same applicant as the present invention, but since it does not have any waterproof function, it is hard to clean it after used several times. Besides, since the conventional nose hair trimmer does not have any antibacterial function, it has to be often disinfected after used several times.

### PRIOR ART LITERATURE

### Patent Literature

Korean Patent Application Laid-open No. 2004-13331
Korean Patent No. 10-1263248

### DISCLOSURE

### Technical Problem

Accordingly, the present invention has been made in view of the above-mentioned problems occurring in the related art, and it is an object of the present invention to provide a nose hair trimmer having an antibacterial function that is capable of preventing the inside and outside thereof from being contaminated with all types of bacteria in such a way as to allow a portion coming into contact with the inside of the nose to be kept at a clean state while nose hairs are being trimmed, thereby building and keeping more sanitary nose hair trimming environments.

### Technical Solution

To accomplish the above-mentioned object, there is provided a nose hair trimmer having an antibacterial function, including: a case 10 having a battery 13 and a motor 15 accommodated therein and divided into a lower case 11 and an upper case 12 separably coupled to each other; an inner rotating blade unit 40 separably fitted to a rotary shaft 16 of the motor 15; an outer fixed blade holder 20 for covering an upper portion of the case 10 in such a way as to hold the inner rotating blade unit 40 therein; a dome-shaped outer fixed blade 30 located on top of the outer fixed bade holder 20 and having through holes 31 formed thereon to allow nose hairs to be introduced therethrough; and a cap 50 for covering the outer fixed bade holder 20, wherein an antibacterial mesh 21 is placed between top of the inside of the outer fixed blade 30 and top of the inner rotating blade unit 40, and the antibacterial mesh 21 is made by coating a mesh made of copper wires with 99.99% purity to a size of a diameter 0.05 m to 0.5 m with an antibacterial solvent comprising 0.5 to 5% by weight of titanium dioxide, 1 to 10% by weight of silicon dioxide, 0.2 to 3% by weight of nickel, 30 to 80% by weight of ethanol, and 5 to 30% by weight of water. including:

According to an embodiment of the present invention, on a portion where the lower case 11 and the upper case 12 may be coupled to each other is located a first sealing ring 14, and on a portion where the outer fixed blade holder 20 and the upper case 12 are coupled to each other may be located a second sealing ring 22.

According to an embodiment of the present invention, the case and the outer fixed blade may have plated layers formed on the surfaces thereof, and each plated layer has an antibacterial layer coated on the thereof surface with an inorganic antibacterial material containing titanium dioxide performing antibacterial and deodorant functions and nano silver having an antibacterial function, while having photooxidation caused by ultraviolet rays.

According to an embodiment of the present invention, the inorganic antibacterial material coated on the surface of the plated layer may include 100 to 700 PPM of nano silver contained in a solvent comprising 0.5 to 5% by weight of titanium dioxide, 1 to 10% by weight of silicon dioxide, 0.2 to 3% by weight of aluminum oxide, 30 to 80% by weight of ethanol, and 5 to 30% by weight of water.

### Advantageous Effects of Invention

According to the present invention, the nose hair trimmer having an antibacterial function is configured to allow the antibacterial solvent to be coated onto the antibacterial mesh and to allow the antibacterial layers to be formed on the case and the outer fixed blade, thereby causing photooxidation to perform antibacterial and deodorant actions.

Further, the nose hair trimmer having an antibacterial function according to the present invention is configured to have the antibacterial layer coated with the inorganic antibacterial material containing nickel and nano silver having antibacterial actions, thereby being always kept at disinfection and deodorization environments, so that even though the nose hair trimmer is frequently used, a sanitary clean state is consistently maintained to improve the cleanness and stability in the sanitary environment of the nose hair trimmer and in the sanitary environment around the nose hair trimmer.

### BRIEF DESCRIPTION OF DRAWINGS

FIG. 1 is a perspective view showing a nose hair trimmer having an antibacterial function according to the present invention.

FIG. 2 is an exploded perspective view showing the nose hair trimmer of FIG. 1.

FIG. 3 is an exploded perspective view showing an inner rotating blade unit of the nose hair trimmer according to the present invention.

FIG. 4 is a sectional view showing an installation structure of a rotating blade of the nose hair trimmer according to the present invention.

### BEST MODE FOR INVENTION

Hereinafter, example embodiments will be described with reference to the accompanying drawings; however, for reference numerals, with respect to the same elements, even though they may be displayed in different drawings, such elements use same reference numerals as much as possible. Also, in explaining the example embodiments, detailed description on known elements or functions will be omitted if it is determined that such description will interfere with understanding of the embodiments. In addition, the example embodiments may be embodied in different forms and should not be construed as limited to the embodiments set forth herein but may be modified and variously implemented by those skilled in the art.

The terms used in the present invention are to be given their ordinary and customary meaning to a person of ordinary skill in the art, and are not to be limited to a special or customized meaning unless expressly so defined herein. It should be noted that the use of particular terminology when describing certain features or aspect of the disclosure should not be taken to imply that the terminology is being re-defined herein to be restricted to include any specific characteristics of the features or aspects of the disclosure with which that terminology is associated.

Terms, such as the first, the second, and the like may be used to describe various elements, but the elements should not be restricted by the terms. The terms are used to only distinguish one element from the other element. For example, a first element may be named a second element without departing from the scope of the present invention.

When it is said that one element is described as being “connected” or “coupled” to the other element, one element may be directly connected or coupled to the other element, but it should be understood that another element may be present between the two elements. In contrast, when it is said that one element is described as being “directly connected” or “directly coupled” to the other element, it should be understood that another element is not present between the two elements. It will be understood that when an element is referred to as being “between” two elements, “just between” two elements, “adjacent to” another element, or “directly adjacent to” another element, it can be the only element between the two elements, or one or more intervening elements may also be present.

Terms used in this application are used to only describe specific exemplary embodiments and are not intended to restrict the present invention. An expression referencing a singular value additionally refers to a corresponding expression of the plural number, unless explicitly limited otherwise by the context. In this application, terms, such as “comprise”, “include”, or ‘have”, are intended to designate those characteristics, numbers, steps, operations, elements, or parts which are described in the specification, or any combination of them that exist, and it should be understood that they do not preclude the possibility of the existence or possible addition of one or more additional characteristics, numbers, steps, operations, elements, or parts, or combinations thereof.

All terms used herein, including technical or scientific terms, unless otherwise defined, have the same meanings which are typically understood by those having ordinary skill in the art. The terms, such as ones defined in common dictionaries, should be interpreted as having the same meanings as terms in the context of pertinent technology, and should not be interpreted as having ideal or excessively formal meanings unless clearly defined in the specification.

Hereinafter, an explanation of a nose hair trimmer having an antibacterial function according to the present invention will be given in detail with reference to the attached drawings.

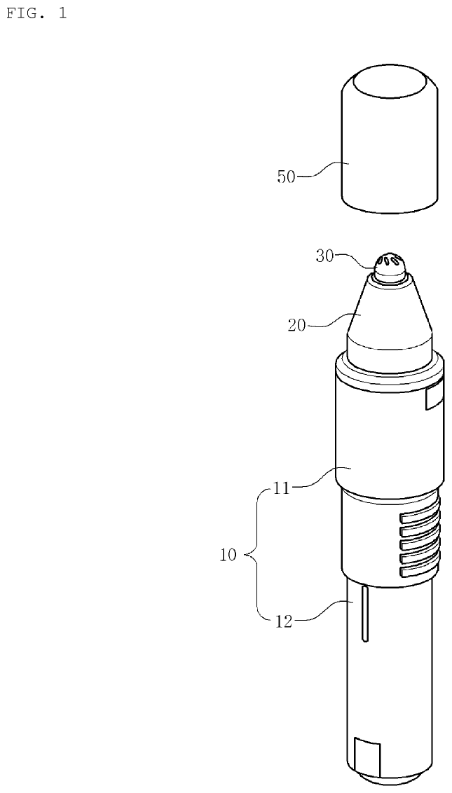

FIG. 1 is a perspective view showing a nose hair trimmer having an antibacterial function according to the present invention. Referring to FIG. 1, the entire outer shape of the nose hair trimmer having an antibacterial function according to the present invention is taken by mounting an outer fixed blade holder 20 onto a case 10, locating a dome-shaped outer fixed blade 30 on the outer fixed blade holder 20, and covering the outer fixed blade holder 20 with a cap 50.

### MODE FOR INVENTION

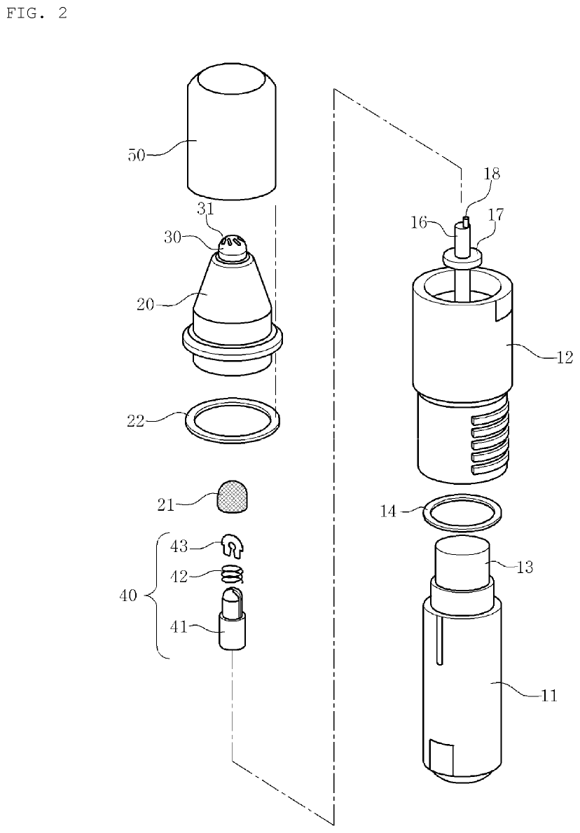

FIG. 2 is an exploded perspective view showing the nose hair trimmer of FIG. 1. Referring to FIG. 2, the case 10 includes a lower case 11 where a battery 13 is accommodated and an upper case 12 where a motor 15 is accommodated, and the lower case 11 and the upper case 12 are fastened to each other, while placing a first sealing ring 14 therebetween. Further, the outer fixed blade holder 20 and the upper case 12 are fastened to each other, while placing a second sealing ring 22 on a portion where they are coupled to each other. As a result, the first sealing ring 14 and the second sealing ring 22 serve to provide waterproof functions so that water is prevented from entering the battery 13 and the motor 15.

For reference, an IPX5 waterproof level represents a high waterproof level where a device is protected for three minutes from 12.5 liter of water that sprays per minute in every direction within a distance of 3 m, an IPX6 waterproof level represents a high waterproof level where a device is protected for three minutes from 30 liter of water that strongly sprays per minute in every direction within a distance of 3 m, and an IPX7 waterproof level represents a high waterproof level where a device is useable for 30 minutes in a state of being submerged into water having a depth of 15 cm to 1 m.

Accordingly, even though the nose hair trimmer according to the present invention is used in a bathroom or the like where water is frequently used or washed after nose hairs have been trimmed, the nose hair trimmer is kept with such an excellent waterproof function, thereby basically preventing all types of malfunctions caused when water enters the case 10 and the outer fixed blade holder 20 from occurring.

Further, the motor 15 has a rotary shaft 16 located thereon along the vertical direction of the case 10. A holder locking projection 17 protrudes from the rotary shaft 16 in a vertical direction to the rotary shaft 16. Furthermore, a separation prevention protrusion 18 protrudes from top of the rotary shaft 16.

An inner rotating blade unit 40 is separably fitted to the rotary shaft 16. The inner rotating blade unit 40 consists of a rotating blade holder 41, a spring 42, and a rotating blade 43.

Further, an antibacterial mesh 21 is placed between top of the inside of the outer fixed blade 30 and top of the inner rotating blade unit 40, and the antibacterial mesh 21 is made by coating a mesh made of copper wires with 99.99% purity to a size of a diameter 0.05 m to 0.5 m with an antibacterial solvent comprising 0.5 to 5% by weight of titanium dioxide, 1 to 10% by weight of silicon dioxide, 0.2 to 3% by weight of nickel, 30 to 80% by weight of ethanol, and 5 to 30% by weight of water. For example, a method for coating the copper wires with the antibacterial solvent is performed by means of application, and of course, various methods may be used as the coating method, without being limited thereto. To be more specific, the copper wires constituting the antibacterial mesh 21 may be made of copper and copper alloys, which are well known as having useful antibacterial properties. Further, it is well known that nickel has antibacterial properties. In this case, the copper alloys may contain small amounts of Ni and Al, and otherwise, they may contain about 15% by weight or less of Zn and/or Mn. The copper wires are made by casting copper or copper alloys to wires and molding the cast wires to fine wires through drawing, and the molded wires are woven to provide the mesh. If the antibacterial mesh 21 is applied to a portion coming into direct contact with the skin, an excellent antibacterial function is exerted to prevent bacteria from growing and thus provide deodorization effect to the nose hair trimmer, so that the nose hair trimmer is useable at a sanitary environment.

Further, antibacterial layers are formed on the surfaces of the case 10 and the outer fixed blade 30. Plated layers formed on the surfaces of the case 10 and the outer fixed blade 30 have antibacterial layers formed on the surfaces thereof, and each antibacterial layer is coated with an inorganic antibacterial material containing titanium dioxide performing antibacterial and deodorant functions and nano silver having an antibacterial function, while having photooxidation caused by ultraviolet rays, so that the antibacterial layer is formed on a portion held by the user's hand or a portion coming into contact with the inner skin of the nostril. Like this, the inorganic antibacterial material coated on the surface of the plated layer comprises 100 to 700 PPM of nano silver contained in a a solvent comprising 0.5 to 5% by weight of titanium dioxide, 1 to 10% by weight of silicon dioxide, 0.2 to 3% by weight of aluminum oxide, 30 to 80% by weight of ethanol, and 5 to 30% by weight of water. The antibacterial layer is the formed by applying inorganic antibacterial material to the surface of the plated layer by means of spray, impregnation, and the like and then dried naturally or by means of a heat treatment.

Further, titanium dioxide as one of the ingredients of the inorganic antibacterial material constituting the antibacterial layer is a semiconductor type metal oxide that produces oxidation-reduction radicals from light energy and thus exhibits strong oxidation properties with respect to organic materials adjacent thereto, silver nano is widely known as having antibacterial properties, and silicon dioxide has oxidation prevention properties from ultraviolet rays.

The titanium dioxide, the nano silver, and the silicon dioxide are synthesized to a microcapsule-type compound or mixture by coating the titanium dioxide as a photosensitive catalyst and the silicon dioxide as an oxidation prevention material onto the surface of the nano silver as an antibacterial metal by means of a sol-gel process as one of coating methods, and in this case, ethanol and water are added to the compound or mixture and agitated for a given time, so that the inorganic antibacterial material is made.

The case 10 of the nose hair trimmer according to the present invention, which has the antibacterial layer formed by coating the inorganic antibacterial material on the surface thereof to provide the antibacterial function, produces active oxygen and OH radicals on photocatalyst to perform strong oxidation-reduction, effectively dissolves and removes nondegradable organic compounds, harmful bacteria, and molds through the antibacterial action of the nano silver, and dissolves and purifies odorous materials.

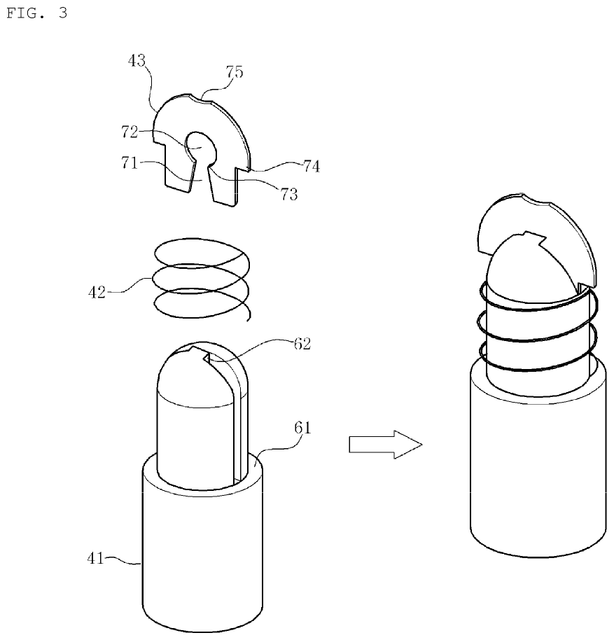

FIG. 3 is an exploded perspective view showing the inner rotating blade unit 40 of the nose hair trimmer according to the present invention. Referring to FIG. 3, the rotating blade holder 41 is fitted to the rotary shaft 16 in a direction from top to bottom of the rotary shaft 16 in such a way as to come into contact with the locking projection 17 of the rotary shaft 16, and so as to prevent the rotating blade holder 41 from being kept spinning and thus separated from the rotary shaft 16, in this case, the rotating blade holder 41 has a separation prevention groove (not shown) formed on the underside thereof in such a way as to insert the separation prevention protrusion 18 of the rotary shaft 16. The rotating blade holder 41 has a spring locking projection 61 protruding outwardly from the outer peripheral surface thereof and allows both sides facing each other on a portion above the spring locking projection 61 to be open long vertically in such a way as to locate a rotating blade fitting stand 62 on a central position of the open portion. The spring 42 is located between spring locking projections 74 of the rotating blade 43 and the spring locking projection 61 of the rotating blade holder 41.

Further, the rotating blade 43 has a fitting groove 70 formed upwardly from the underside thereof, and to allow the fitting groove 70 to be fitted to the rotating blade fitting stand 62, the rotating blade 43 is mounted on the rotating blade holder 41. The upper portion of the rotating blade 43 has the shape of a semicircle, and the spring locking projections 74 are formed on both sides of the rotating blade 43. Desirably, the rotating blade 43 has a concave portion 75 formed on top thereof.

Further, the fitting groove 70 includes a reduced diameter portion 71 becoming narrow in width from the underside of the rotating blade 43 toward top thereof and a circular portion 72 extending upward from the reduced diameter portion 71.

Accordingly, a bottle neck portion 73 is formed between the reduced diameter portion 71 and the circular portion 72.

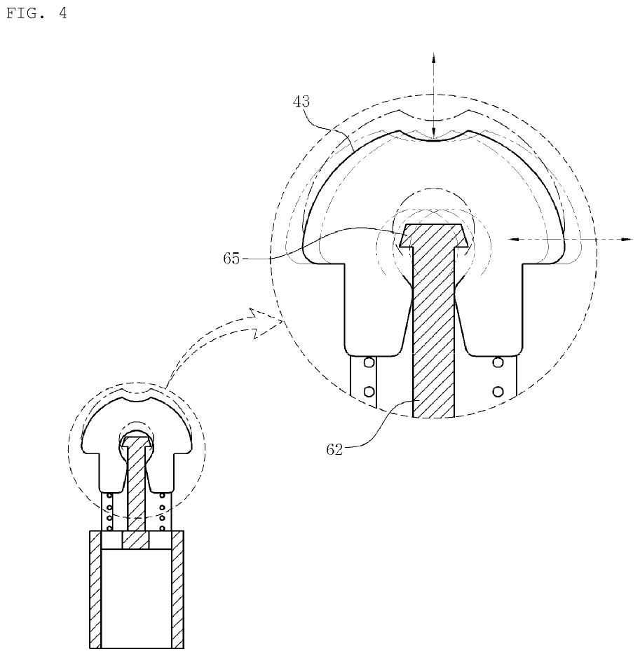

FIG. 4 is a a sectional view showing an installation structure of the rotating blade 43 of the nose hair trimmer according to the present invention, wherein a dash-single dotted line represents upward and downward movements of the rotating blade 43, and a dash-double dotted line represents left and right movements of the rotating blade 43. Referring to FIG. 4 that is based on FIG. 3, the rotating blade fitting stand 62 has an escape prevention protrusion 65 protruding from top thereof in such a way as to be inserted into the circular portion 72 of the fitting groove 70. Since the size of the escape prevention protrusion 65 is bigger than the width of the bottle neck portion 73, the escape prevention protrusion 65 fitted to the circular portion 72 does not escape from the circular portion 72 due to the existence of the bottle neck portion 73.

Further, since the height of the circular portion 72 is bigger than the height of the escape prevention protrusion 65, the rotating blade 43 is movable up and down, while being fitted to the escape prevention protrusion 65.

The escape prevention protrusion 65 becomes tapered upwardly therefrom. This is to allow the reduced diameter portion 71 to be naturally open when the reduced diameter portion 71 is fitted to the escape prevention protrusion 65 so that the escape prevention protrusion 65 can be inserted into the circular portion 72, and further, as shown in FIG. 4, this ensures the left and right movements of the rotating blade 43.

Hereinafter, an explanation of the operating state of the nose hair trimmer according to the present invention will be explained. If the outer fixed blade holder 20 is inserted into the nose after the cap 40 has been removed, the nose hairs enter through holes 31 formed on the outer fixed blade 30. In this case, as the inner rotating blade unit 40 rotates, the nose hairs are trimmed by means of the rotating blade 43 in a state of being somewhat fixedly fitted to the through holes 31. The nose hairs do not need to be trimmed very short, and accordingly, the side portions of the through holes 31 of the outer fixed blade 30 do not need to be sharp. This is to protect the inner skin of the nose safely.

When the nose hair trimmer comes into contact with the inner skin of the nose by the application of excessive force, the skin sucks to the through holes 31 of the outer fixed blade 30 and thus gets hurt, and in this case, it is possible that the rotating blade 43 moves up and down and becomes slanted to left and right, while the antibacterial mesh 21 is being located, so that the inner skin of the nose is prevented from getting hurt. Further, as the concave portion 75 is formed on top of the rotating blade 43 to prepare a safety accident that may happen, the skin damage caused by the rotating blade 43 is more reliably prevented.

The nose hairs are thin, weak, long, and a little entangled, unlike relatively strong beard or sideburns, and therefore, it is not easy that the nose hairs enter a portion where the rotating blade 43 is located via the through holes 31 of the outer fixed blade 30. According to the present invention, however, it is possible that the rotating blade 43 is slanted to left and right, and accordingly, if the nose hairs enter any one side of the rotating blade 43, the rotating blade 43 becomes slanted to one side to allow the nose hairs to be easily introduced thereunder. Because the rotating blade 43 rotates at a high speed, in this case, such a phenomenon occurs smoothly.

According to the present invention, as mentioned above, it is possible that the rotating blade 43 moves up and down and becomes slanted to left and right, and accordingly, the nose hairs, which are thin, weak, long, and a little entangled, are easily introduced under the rotating blade 43 and trimmed smoothly.

Although the specific embodiment of the nose hair trimmer having the antibacterial function according to the present invention has been illustrated and described herein, it will be appreciated by those of ordinary skill in the art that the embodiment may be easily modified to other specific embodiments, without changing in the technical spirit and necessary features of the present invention. This application is intended to cover any adaptations or variations of the present invention. Therefore, it is manifestly intended that this invention be limited only by the claims and the equivalents thereof. For example, the parts expressed in a singular form may be dispersedly provided, and in the same manner as above, the parts dispersed may be combined with each other.

This application is intended to cover any adaptations or variations of the present invention. Therefore, it is manifestly intended that this invention be limited only by the claims and the equivalents thereof.

[Explanations of Reference Numerals]

| | |
|---|---|
| 10: Case | 11: Lower case |
| 12: Upper case | 13: Battery |
| 14: First sealing ring | 15: Motor |
| 16: Rotary shaft | 17: Holder locking projection |
| 18: Separation preventing protrusion | 20: Outer fixed blade holder |
| 21: Antibacterial mesh | 22: Sealing ring |
| 30: Outer fixed blade | 31: Through hole |
| 40: Inner rotating blade unit | 41: Rotating blade holder |
| 42: Spring | 43: Rotating blade |
| 50: Cap | 61, 74: Spring locking projection |
| 62: Rotating blade fitting stand | 65: Escape prevention protrusion |
| 70: Fitting groove | 71: Reduced diameter portion |
| 72: Circular portion | 73: Bottle neck portion |
| 75: Concave portion | |

1. A nose hair trimmer having an antibacterial function, comprising:
a case (10) having a battery (13) and a motor (15) accommodated therein and divided into a lower case (11) and an upper case (12) separably coupled to each other;
an inner rotating blade unit (40) separably fitted to a rotary shaft (16) of the motor (15);
an outer fixed blade holder (20) for covering an upper portion of the case (10) in such a way as to hold the inner rotating blade unit (40) therein;
a dome-shaped outer fixed blade (30) located on top of the outer fixed bade holder (20) and having through holes (31) formed thereon to allow nose hairs to be introduced therethrough; and
a cap (50) for covering the outer fixed bade holder (20),
wherein an antibacterial mesh (21) is placed between top of the inside of the outer fixed blade (30) and top of the inner rotating blade unit (40), and the antibacterial mesh (21) is made by coating a mesh made of copper wires with 99.99% purity to a size of a diameter 0.05 m to 0.5 m with an antibacterial solvent comprising 0.5 to 5% by weight of titanium dioxide, 1 to 10% by weight of silicon dioxide, 0.2 to 3% by weight of nickel, 30 to 80% by weight of ethanol, and 5 to 30% by weight of water.

2. The nose hair trimmer according to claim 1, wherein on a portion where the lower case (11) and the upper case (12) are coupled to each other is located a first sealing ring (14), and on a portion where the outer fixed blade holder (20) and the upper case (12) are coupled to each other is located a second sealing ring (22).

3. The nose hair trimmer according to claim 1, wherein the case (10) and the outer fixed blade (30) have plated layers formed on the surfaces thereof, and each plated layer has an antibacterial layer coated on the surface thereof with an inorganic antibacterial material containing titanium dioxide performing antibacterial and deodorant functions and nano silver having an antibacterial function, while having photooxidation caused by ultraviolet rays.

4. The nose hair trimmer according to claim 3, wherein the inorganic antibacterial material coated on the surface of the plated layer comprises 100 to 700 PPM of nano silver contained in a solvent comprising 0.5 to 5% by weight of titanium dioxide, 1 to 10 by weight of silicon dioxide, 0.2 to 3 by weight of aluminum oxide, 30 to 80 by weight of ethanol, and 5 to 30 by weight of water.
